(19) United States
(12) Patent Application Publication
(10) Pub. No.: US 2003/0196954 A1
(43) Pub. Date: Oct. 23, 2003

(54) Method for manufacturing activated carbon from coffee waste

(75) Inventors: Nae-Wen Kuo, Taipei (TW); Pei-Chuan Wu, Junghe City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: King Car Food Industrial Co., Ltd., Taipei (TW)

(21) Appl. No.: 10/417,551

(22) Filed: Apr. 17, 2003

(30) Foreign Application Priority Data
Apr. 19, 2002 (TW) 091108166

(51) Int. Cl. B01D 11/04

(52) U.S. Cl. 210/634; 210/669; 210/774; 426/594

(57) ABSTRACT

The present invention provides a method for manufacturing the activated carbon from the coffee waste. The method includes steps of immersing the coffee waste in an activator solution so that the activator adsorbs on a surface of the coffee waste, and transferring the immersed coffee waste into a high temperature-rotary reactor for proceeding a reaction of carbonization and activation to result in the activated carbon product having a high specific surface area. Therefore, the present invention can efficiently transform the coffee waste into the activated carbon product used in industries of environment engineering and foodstuff, so as to achieve the object of recycling the waste.

### FIELD OF THE INVENTION

This invention relates to a method for manufacturing the activated carbon, and more particularly to a method for manufacturing the activated carbon from the coffee waste.

### BACKGROUND OF THE INVENTION

The activated carbon has a special pore structure and is a collective noun of a porous carbon. Since the activated carbon has a high specific surface area (500-1500 m²/g), it is suitable for absorbing organic pollutants and widely used in industries of environment engineering, foodstuff and medicine.

There are four types of the activated carbon:

1. Granulated activated carbon (GAC): It is mainly used in treatment and recycling of volatile organic compounds (VOCs), air purification (such as deodorization), and prevention of air pollution.

2. Powdered activated carbon (PAC): It is mainly used in water purification engineering (such as the treatment of trihalomethane), waste water engineering, and foodstuff industry (such as decoloration).

3. Shaped activated carbon: The activated carbon is re-processed and shaped to form a particular shape to meet the requirements of the intended application. For example, the shaped activated carbon can be used for absorbing gas or as carriers for catalysts.

4. Activated carbon fiber: The activated carbon is formed as a fibrous non-woven cloth for reducing the pressure loss and recovering organic solvents in the semiconductor manufacturing process. It can also be used as the filter of an air cleaner or air conditioner.

The activated carbon is usually manufactured from the materials containing high carbon and low inorganic matter, such as materials from animals, plants and minerals. The materials are treated by optimal processes (such as thermal pyrolysis reaction) to result in the activated carbon.

In the current study, the materials used for manufacturing the activated carbon includes the peat, lignite, brown coal, bituminous coal, coconut shell, wood, waste bamboo chopstick, wood flour, nut shell, bagasse, heavy oil residue, petroleum coke, waste tire, mud, rice husk, corn tassel and brown sugar.

In general, the activated carbon manufactured from the coconut shell and nut shell with high density and high volatility is suitable for use in air purification or treatment and recycling of volatile organic compounds (VOCs), while the activated carbon manufactured from the wood and lignin with low density is suitable for use in water purification engineering.

The coffee waste is the food waste from the manufacturing factories of the coffee drinks and the related products. With the ascendant fashion of drinking coffee, the coffee waste is increased accordingly which increases the environment loading. If the coffee waste can be recycled, not only the waste problem can be solved, but a new use value of the coffee waste can be developed.

Therefore, the present invention provides an idea for recycling the coffee waste to further transform the coffee waste into the activated carbon product used in industries of environment engineering and foodstuff, so as to achieve the object of recycling the waste.

### SUMMARY OF THE INVENTION

It is an object of the present invention to provide a method for manufacturing the activated carbon from the coffee waste so as to recycle the waste.

It is another object of the present invention to provide a method for manufacturing the activated carbon from the coffee waste, in which the activated carbon has a high specific surface area.

In accordance with an aspect of the present invention, the method for manufacturing the activated carbon from the coffee waste includes steps of immersing the coffee waste in an activator solution so that the activator adsorbs on a surface of the coffee waste, and transferring the immersed coffee waste into a high temperature-rotary reactor for proceeding a reaction of carbonization and activation to result in a rough activated carbon.

Preferably, the activator is a carbonate.

Preferably, the carbonate is one selected from a group consisting of a potassium carbonate, a calcium carbonate, a magnesium carbonate and a mixture thereof.

Preferably, a concentration of the activator solution ranges from 10% to 40%.

Preferably, a time of the immersing step ranges from 1 to 2 hours.

Preferably, a temperature of the reaction in the high temperature-rotary reactor ranges from 700 to 900° C.

Preferably, the temperature is reached by a temperature-increasing rate of 10° C./min.

Preferably, a time of the reaction ranges from 1 to 3 hours.

Preferably, the high temperature-rotary reactor includes a thermal pyrolysis tube.

Preferably, the thermal pyrolysis tube is made of stainless steel.

Preferably, the high temperature-rotary reactor further includes a gas bottle for providing a gas to exclude the air in the thermal pyrolysis tube, so that the reaction is proceeded without oxygen.

Preferably, the gas is nitrogen.

Preferably, the rough activated carbon is further processed by a later treatment to result in the activated carbon.

Preferably, the later treatment includes steps of acid-washing and water-washing the rough activated carbon, immersing the rough activated carbon in acetone and shaking by ultrasound for 1 hour, filtering out the acetone, washing the rough activated carbon by a distilled water, and baking the rough activated carbon at 200° C. for 12 to 24 hours to result in the activated carbon.

Preferably, the acid-washing step is to treat the rough activated carbon with 0.5N HCl at 85° C. for 30 min, and remove a filtrate by an air-extracting filter.

Preferably, the water-washing step is to treat the rough activated carbon with 85° C. distilled water for 30 min, and remove a filtrate by an air-extracting filter.

Preferably, the water-washing step is repeated until a pH value of the filtrate is higher than 6.

Preferably, a specific surface area of the activated carbon ranges from 726 to 1317 m²/g.

In accordance with another aspect of the present invention, the activated carbon is manufactured from the coffee waste.

Preferably, the activated carbon is manufactured by the following steps of immersing the coffee waste in an activator solution so that the activator adsorbs on a surface of the coffee waste, and transferring the immersed coffee waste into a high temperature-rotary reactor for proceeding a reaction of carbonization and activation to result in a rough activated carbon.

Preferably, the activator is a carbonate.

Preferably, the carbonate is one selected from a group consisting of a potassium carbonate, a calcium carbonate, a magnesium carbonate and a mixture thereof.

Preferably, a concentration of the activator solution ranges from 10% to 40%.

Preferably, a temperature of the reaction in the high temperature-rotary reactor ranges from 700 to 900° C.

Preferably, the temperature is reached by a temperature-increasing rate of 10° C./min.

Preferably, the rough activated carbon is further processed by a later treatment to result in the activated carbon.

Preferably, a specific surface area of the activated carbon ranges from 726 to 1317 m²/g.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a simple flowchart of the method for manufacturing the activated carbon from the coffee waste according to a preferred embodiment of the present invention;

FIG. 2 is a schematic view showing the high temperature-rotary reactor of the present invention; and

FIG. 3 shows the temperature-increasing program of the high temperature-rotary reactor of the present invention.

### DETAILED DESCRIPTION OF THE PREFERRED EMBODIMENT

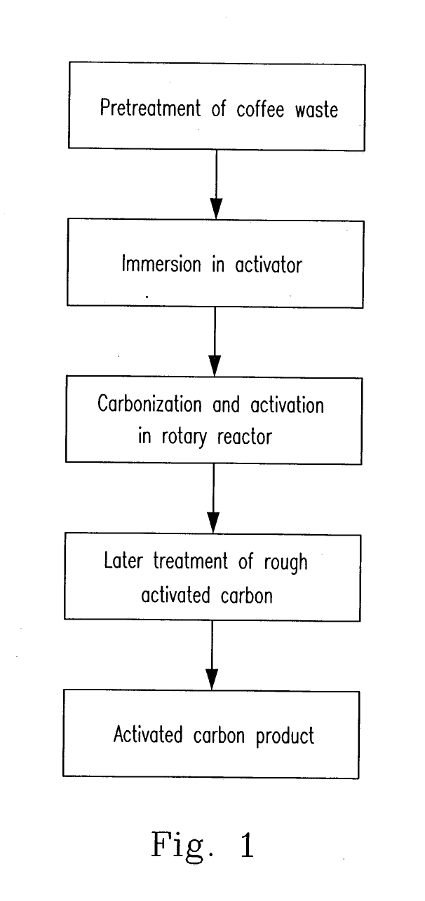

Please refer to FIG. 1 showing a simple flowchart of the method for manufacturing the activated carbon from the coffee waste according to the present invention. The manufacturing steps are described in detail as follows:

1. Pretreatment of the Coffee Waste

The coffee waste is washed and baked, and the impurities in the coffee waste is picked out after the coffee waste is cooled down. Then the coffee waste is grinded.

2. Immersion in the Activator Solution

The pretreated coffee waste is immersed in a chemical activator of carbonate, such as potassium carbonate, calcium carbonate, magnesium carbonate and a mixture thereof, so that the activator can adsorb on the surface of the coffee waste. The concentration of the activator solution preferably ranges from 10% to 40%. After immersion for 1 to 2 hours, the coffee waste is filtered and dried.

3. Carbonization and Activation in the Rotary Reactor

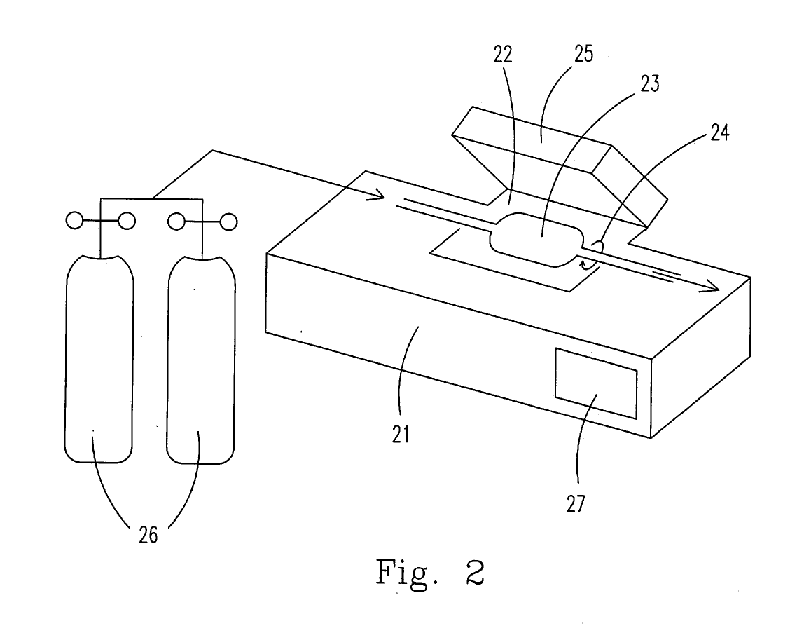

The dried coffee waste (100 g) formed from the above step is transferred into a high temperature-rotary reactor. The structure of the high temperature-rotary reactor is shown in FIG. 2. The body 21 of the rotary reactor is a hollow and openable cuboid with a height of 100 cm. The highest temperature of the rotary reactor can be 1050° C., and the rotary reactor has a temperature controller to control the temperature-increasing rate and the heating time, and keep a constant temperature during the reaction period. The heating area 22 of the body 21 includes a thermal pyrolysis reaction tube 23 made of stainless steel. The thermal pyrolysis reaction tube 23 has a length of about 90 cm, a wall thickness of 0.5 cm, and an inner diameter of 3.5 cm. The preheating area of the reaction tube 23 is about 25 cm, and the constant temperature area is about 50 cm. The reaction tube 23 itself can be rotated in a clockwise or counterclockwise direction (as shown as the numeral 24 in FIG. 2) to facilitate the proceeding of the reaction. In addition, there is a protecting plate 25 covering on the heating area 22 to keep the temperature of the heating area 22.

The high temperature-rotary reactor further includes a gas bottle 26 for providing nitrogen to exclude the air in the thermal pyrolysis reaction tube, so that the thermal pyrolysis reaction can be proceeded without oxygen, and the gas product can be carried out simultaneously.

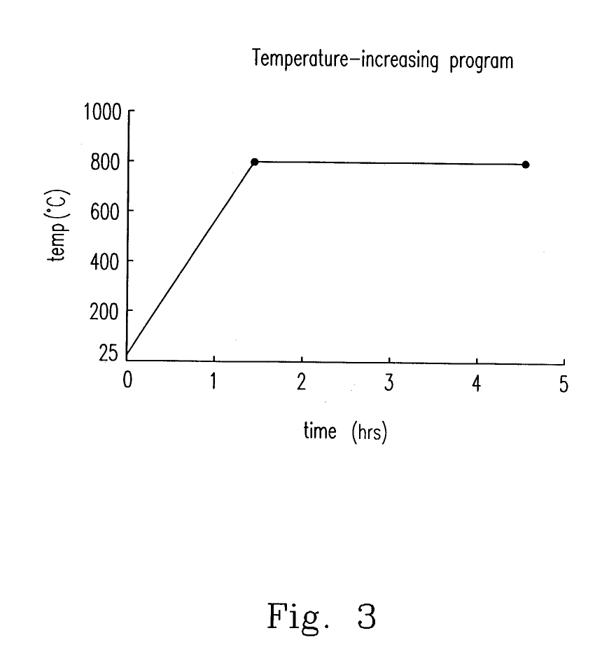

According to a preferred embodiment of the present invention, the coffee waste is put into the thermal pyrolysis reaction tube 23, and the protecting plate 25 is covered on the heating area 22. The temperature-increasing program can be set from the operating panel 27. The gas bottle 26 is opened to fill the thermal pyrolysis reaction tube 23 with the nitrogen. The temperature is increased by an increasing rate of 10° C./min to 700-900° C. (the temperature-increasing program is shown in FIG. 3), and then the temperature is kept for 1 to 3 hours to proceed the thermal pyrolysis reaction so as to complete the carbonization and activation process and result in a rough activated carbon sample.

4. Later Treatment of the Rough Activated Carbon

The rough activated carbon sample is treated with 250 ml 0.5N HCl solution for acid-washing at 85° C. for 30 min, and the filtrate is removed by an air-extracting filter. Then the sample is treated with 85° C., 250 ml distilled water for water-washing for 30 min, and the filtrate is also removed by the air-extracting filter. The water-washing step is repeated until the pH value of the filtrate is higher than 6. The sample is immersed in acetone and shaken by ultrasound for 1 hour, and then the acetone is filtered out by the air-extracting filter. Also, this step is repeated until the filtrate is clear. Finally, the sample is washed by distilled water for several times. The sample is transferred into an oven and baked at 200° C. for 12 to 24 hours, and then transferred into a vacuum dry box to be vacuumed and cooled down, so as to result in the activated carbon product.

The specific surface area of the activated carbon product manufactured from the above-mentioned steps is measured by Micromeritics Instrument Corporation ASAP, type 2000 and 2001 (the measurements are commissioned to the departments of chemical engineering of National Taiwan University and National Central University). The measured specific surface area of the activated carbon product is about 726-1317 m²/g. Table 1 shows the specific surface areas of the activated carbons manufactured from different materials and methods (with different activators).

TABLE 1

| material (activator) | specific surface area |
|---|---|
| commercial product A | 300-600 |
| commercial product B | 950-1050 |
| waste bamboo chopstick (steam) | 719 |
| brown sugar (steam) | 688 |
| mud (ZnCl₂) | 585 |
| rice husk (ZnCl₂) | 1134 |
| corn tassel (ZnCl₂) | 1410 |
| bagasse (steam) | 657 |
| peanut shell (steam) | 549 |
| pistachio nutshell (steam) | 586 |
| longan kernel (steam) | 584 |
| peach kernel (steam) | 632 |
| olive kernel (steam) | 656 |
| coffee waste (K₂CO₃) | 1317 |

In conclusion, the activated carbon manufactured from the coffee waste by the method of the present invention has a high specific surface area of 1317 m²/g, so the activated carbon has a very good absorbing efficiency. Therefore, the present invention can efficiently transform the coffee waste into the activated carbon product used in industries of environment engineering and foodstuff, so as to achieve the object of recycling the waste.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for manufacturing an activated carbon from a coffee waste, comprising steps of:
immersing said coffee waste in an activator solution so that said activator adsorbs on a surface of said coffee waste; and
transferring said immersed coffee waste into a high temperature-rotary reactor for proceeding a reaction of carbonization and activation to result in a rough activated carbon.

2. The method according to claim 1 wherein said activator is a carbonate.

3. The method according to claim 2 wherein said carbonate is one selected from a group consisting of a potassium carbonate, a calcium carbonate, a magnesium carbonate and a mixture thereof.

4. The method according to claim 1 wherein a concentration of said activator solution ranges from 10% to 40%.

5. The method according to claim 1 wherein a time of said immersing step ranges from 1 to 2 hours.

6. The method according to claim 1 wherein a temperature of said reaction in said high temperature-rotary reactor ranges from 700 to 900° C.

7. The method according to claim 6 wherein said temperature is reached by a temperature-increasing rate of 10° C./min.

8. The method according to claim 6 wherein a time of said reaction ranges from 1 to 3 hours.

9. The method according to claim 1 wherein said high temperature-rotary reactor comprises a thermal pyrolysis tube.

10. The method according to claim 9 wherein said thermal pyrolysis tube is made of stainless steel.

11. The method according to claim 9 wherein said high temperature-rotary reactor further comprises a gas bottle for providing a gas to exclude the air in said thermal pyrolysis tube, so that said reaction is proceeded without oxygen.

12. The method according to claim 11 wherein said gas is nitrogen.

13. The method according to claim 1 wherein said rough activated carbon is further processed by a later treatment to result in said activated carbon.

14. The method according to claim 13 wherein said later treatment comprises steps of:
acid-washing and water-washing said rough activated carbon;
immersing said rough activated carbon in acetone and shaking by ultrasound for 1 hour;
filtering out said acetone;
washing said rough activated carbon by a distilled water; and
baking said rough activated carbon at 200° C. for 12 to 24 hours to result in said activated carbon.

15. The method according to claim 14 wherein said acid-washing step is to treat said rough activated carbon with 0.5N HCl at 85° C. for 30 min, and remove a filtrate by an air-extracting filter.

16. The method according to claim 14 wherein said water-washing step is to treat said rough activated carbon with 85° C. distilled water for 30 min, and remove a filtrate by an air-extracting filter.

17. The method according to claim 16 wherein said water-washing step is repeated until a pH value of said filtrate is higher than 6.

18. The method according to claim 14 wherein a specific surface area of said activated carbon ranges from 726 to 1317 m²/g.

19. An activated carbon manufactured from a coffee waste.

20. The activated carbon according to claim 19 wherein said activated carbon is manufactured by the following steps of:
immersing said coffee waste in an activator solution so that said activator adsorbs on a surface of said coffee waste; and
transferring said immersed coffee waste into a high temperature-rotary reactor for proceeding a reaction of carbonization and activation to result in a rough activated carbon.

21. The activated carbon according to claim 20 wherein said activator is a carbonate.

22. The activated carbon according to claim 21 wherein said carbonate is one selected from a group consisting of a potassium carbonate, a calcium carbonate, a magnesium carbonate and a mixture thereof.

23. The activated carbon according to claim 20 wherein a concentration of said activator solution ranges from 10% to 40%.

24. The activated carbon according to claim 20 wherein a temperature of said reaction in said high temperature-rotary reactor ranges from 700 to 900° C.

25. The activated carbon according to claim 24 wherein said temperature is reached by a temperature-increasing rate of 10° C./min.

26. The activated carbon according to claim 20 wherein said rough activated carbon is further processed by a later treatment to result in said activated carbon.

27. The activated carbon according to claim 26 wherein a specific surface area of said activated carbon ranges from 726 to 1317 m²/g.
